(19) United States
(12) Patent Application Publication
(10) Pub. No.: US 2007/0116399 A1
(43) Pub. Date: May 24, 2007

(54) Optical element, manufacturing method of the optical element and driving method of the same

(75) Inventors: Keisuke Sato, Kawasaki (JP); Masao Kondo, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 11/385,646

(22) Filed: Mar. 22, 2006

(30) Foreign Application Priority Data
Nov. 22, 2005 (JP) 2005-336713

(51) Int. Cl. G02F 1/295; G02B 6/10; G02B 6/00

(52) U.S. Cl. 385/6; 385/4; 385/129; 385/130; 385/132; 385/141; 385/144

(57) ABSTRACT

A clad having material showing a magnetic resistance effect is formed on a substrate and a PLZT core is formed on the clad. The core is patterned in a Y shape and an input side optical waveguide and output side optical waveguides are formed of the clad and the core. Coils are placed on the output side optical waveguides and an intensity of light, which propagates through an optical waveguide, is controlled by a magnetic field generated by these coils to switch an optical signal.

### CROSS-REFERENCE TO RELATED APPLICATION

This application is based on and claims priority of Japanese Patent Application No. 2005-336713 filed on Nov. 22, 2005, the entire contents of which are incorporated herein by reference.

### BACKGROUND OF THE INVENTION

1. Field of the Invention

The present invention relates to an optical element used in an optical signal transmission system, a manufacturing method of the optical element and a driving method of the same. In particular, the present invention relates to an optical element which controls light by magnetism, a manufacturing method of the optical element and a driving method of the same.

2. Description of the Prior Art

With the advent of advanced information society, an amount of information transmission in optical communications has been growing steadily in recent years. In response to this trend, the technique of wavelength multiplexing and the like have been developed in order to improve transmission efficiency, so that speed and capacity in an optical signal transmission system have been increasing steadily.

Meanwhile, in the optical signal transmission system, an optical element such as an optical modulation element and an optical switch, which controls light, is required, so that various kinds of optical elements have heretofore been developed. One of such optical elements is a mechanically-driven optical element having a movable mirror. However, in the mechanically-driven optical element, there is difficulty in meeting the demand for an increase in a signal transmission speed and miniaturization of element.

Japanese Patent Laid-Open Official Gazette No. 9-318978 (patent document 1) describes an optical element which partially changes a refractive index of an optical waveguide by an electrical field to switch light. The optical element of this kind has an advantage which enables not only a high speed switching of optical signals but also integration on a substrate, and various studies are carried out. However, in the optical element of this kind, a metal thin film electrode must be formed on the optical waveguide and this leads to a drawback that a large optical loss occurs. Various contrivances are needed to reduce the optical loss, causing a problem in which the structure becomes complicated to increase manufacturing cost.

On the other hand, an optical element which controls light by magnetism has been also developed. The optical element of this kind has advantages in which there is no optical loss due to electrodes, a structure is simple and a reaction speed is high. For example, Japanese Patent Laid-Open Official Gazette No. 9-230298 (patent document 2) describes an optical element using a magnetic layer and a polarizer as an optical element of this kind. This optical element rotates a plane of polarization of light, which propagates through the magnetic layer, by a magnetic field applied to the magnetic layer, to control an amount of light passing through the polarizer. This optical element has a drawback in which an optical loss is increased when a region corresponding to a magnetic driving portion is expanded. However, Japanese Patent Laid-Open Official Gazette No. 2004-309700 (patent document 3) describes that the use of a magnetic multilayered film can solve the above drawback.

Moreover, Japanese Patent Laid-Open Official Gazette No. 2000-347135 (patent document 4) describes an optical waveguide in which a clad and a core are formed of a magnetic crystal thin film. However, the optical waveguide described in the patent document 4 is used in a Faraday rotator that forms an optical isolator. Since the Faraday rotator is placed at the subsequent stage of a polarizing element to rotate a plane of polarization of light transmitted through the polarizing element, the optical waveguide described in the patent document 4 does not control an intensity of light, which propagates through the optical waveguide, by a magnetic field.

The optical elements described in the patent document 2 and the patent document 3 are useful to apply to a relatively large-scale optical switch. However, these optical elements cannot be integrated on the substrate since the polarizer must be placed in the optical path.

### SUMMARY OF THE INVENTION

It is an object of the present invention is to provide an optical element capable of controlling light by magnetism and of being integrated on a substrate, a manufacturing method of the optical element and a driving method of the same.

According to one aspect of the present invention, there is provided an optical element comprising: a substrate; an optical waveguide including a clad made of material showing a magnetic resistance effect and a core made of material having a higher refractive index than that of the clad, the optical waveguide being placed on the substrate; and magnetic field applying means which applies a magnetic field to the optical waveguide to control an intensity of light propagating through the optical waveguide.

When no magnetic field is applied to the optical waveguide of the optical element of the present invention, little loss of light, which propagates through the optical waveguide, occurs. However, in the present invention, since the clad is formed of the material showing the magnetic resistance effect, a part of the light, which propagates through the optical waveguide, is absorbed by the clad according to a change in the magnetic resistance of the clad when the magnetic field is applied, so that a large optical loss occurs. Accordingly, for example, at the time when no magnetic field is applied is made to correspond to an on-state and at the time when the magnetic field is applied is made to correspond to an off-state, thereby making it possible to cause the optical element of the present invention to function as an optical switch.

According to another aspect of the present invention, there is provided a manufacturing method of an optical element, comprising the steps of: forming an optical waveguide which includes a clad made of material showing a magnetic resistance effect and a core made of material having a higher refractive index than that of the clad, on a substrate; and placing magnetic field applying means which applies a magnetic field to the optical waveguide, on at least one of upper and lower sides of the substrate.

According to the manufacturing method of the present invention, it is possible to easily manufacture the optical element which controls an amount of loss of light, which propagates through the optical waveguide, by magnetism. Unlike an optical element which controls a refractive index of an optical waveguide by an electric field, the optical element manufactured by the manufacturing method of the present invention has no thin-film metallic electrode on the optical waveguide. Consequently, the optical loss due to the thin-film metal can be avoided. Moreover, since the clad and the core are film-formed on the substrate, integration is easily carried out. Still moreover, since the amount of loss of light, which propagates through the optical waveguide, is controlled by a magnetic field, the high speed operation can be carried out as compared with a mechanically-driven optical element.

According to further another aspect of the present invention, there is provided a driving method of an optical element, in which a magnetic field is applied to an optical waveguide including a clad made of material showing a magnetic resistance effect and a core made of material having a higher refractive index than that of the clad, the optical waveguide being placed on a substrate to control the intensity of light propagating through the optical waveguide.

In the present invention, since the magnetic field is applied to the optical waveguide including the clad made of the material showing the magnetic resistance effect and the core made of the material having the higher refractive index than that of the clad, the optical waveguide being placed on the substrate to control the intensity of light propagating through the optical waveguide, it is possible to switch an optical signal to be input to the optical element and modulate the optical signal.

### BRIEF DESCRIPTION OF THE DRAWINGS

FIG. 1 is a cross-sectional view illustrating one example of an optical waveguide used in an optical element according to the present invention;

FIG. 2 is a view illustrating an examination result of each of the relationship between a length of an optical waveguide and a light intensity when no magnetic field is applied to the optical waveguide and the relationship between the length of the optical waveguide and the light intensity when a magnetic field of 3500G is applied to the optical waveguide by an end surface diffuse reflection method;

FIG. 3 is a schematic view illustrating the end diffuse reflection method;

FIG. 4 is a plane view illustrating an optical element (optical switch) according to a first embodiment of the present invention;

FIG. 5 is a cross-sectional view taken along the line of I-I of FIG. 4;

FIGS. 6A and 6B are schematic views each illustrating an operation of the optical element according to the first embodiment of the present invention;

FIGS. 7A to 7C are cross-sectional views illustrating a manufacturing method of the optical element according to the first embodiment of the present invention, in the order of processes;

FIG. 8A is a perspective view (partially notched state) illustrating an example of a commercial surface-mount type stacked coil, and FIG. 8B is a perspective view illustrating an example of a commercial surface-mount type winding coil;

FIG. 9 is a plane view illustrating an optical element (optical switch) according to a second embodiment of the present invention;

FIG. 10 is a cross-sectional view taken along the line of II-II of FIG. 9;

FIG. 11 is a cross-sectional view illustrating an optical element (optical switch) according to a third embodiment of the present invention;

FIG. 12 is a plane view illustrating an optical element (optical modulator) according to a fourth embodiment of the present invention; and

FIG. 13 is a cross-sectional view taken along the line of III-III of FIG. 12.

### DESCRIPTION OF THE PREFERRED EMBODIMENTS

The following will explain the principle of the present invention before explaining the embodiments of the present invention.

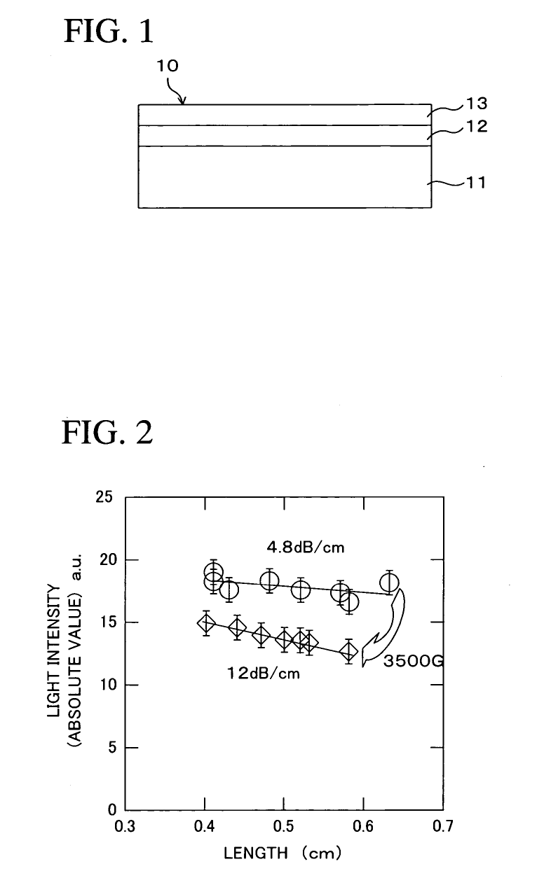

FIG. 1 is a cross-sectional view illustrating one example of an optical waveguide used in an optical element according to the present invention. An optical waveguide 10 is formed by layering a clad 12 made of La_{0.5}Sr_{0.5}CoO₃, and a core 13 made of PLZT (La-doped lead zirconate titanate), on a SrTiO₃ single crystal substrate 11. The core 13 must be formed of material having a high light transmittance and a refractive index higher than that of the clad 12. Moreover, in the present invention, the clad 12 must be formed of material showing a magnetic resistance effect.

When no magnetic field is applied to the optical waveguide 10, light, which was input to the core 13 from one end side of the optical waveguide 10, propagates in the core 13 while being reflected at a boundary surface between the core 13 and the clad 12 or air, thereafter being output from the other end side.

When the magnetic field is applied to the optical waveguide 10, a part of light, which propagates through the optical waveguide 10, is absorbed by the clad 12 with a change in a magnetic resistance of the clad 12, so that a large loss occurs in light propagating through the optical waveguide 10. FIG. 2 is a view illustrating an examination result of each of the relationship between a length of an optical waveguide and a light intensity at the time when no magnetic field is applied to the optical waveguide, and the relationship between the length of the optical waveguide and the light intensity at the time when a magnetic field of 3500G is applied to the optical waveguide by an end surface diffuse reflection method where the length of the optical waveguide is plotted in abscissa and an absolute value of light intensity (relative intensity) is plotted in ordinate.

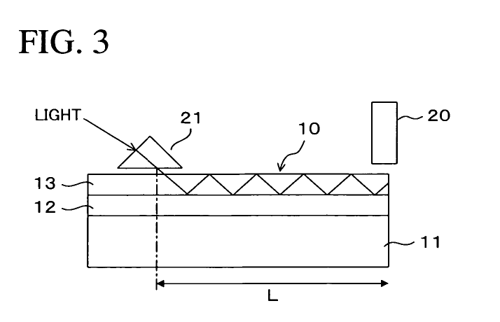

FIG. 3 is a schematic view illustrating the end surface diffuse reflection method. As illustrated in FIG. 3, a detector 20 was placed on an end surface of the optical waveguide 10 and light was introduced into the optical waveguide 10 (core 13) through a prism 21. Moreover, the prism 21 was moved in a length direction of the optical waveguide 10 and light diffusely reflected at the end surface of the optical waveguide 10 was detected by the detector 20. Then, the relationship between a length of the optical waveguide 10 and a light intensity was examined in each of the cases at the time when the magnetic field was applied and at the time when no magnetic field was applied where a distance L, which was from the end surface of the optical waveguide 10 to the prism 21, was a length of the optical waveguide 10 and an output of the detector 20 was a light intensity.

As a result, as illustrated in FIG. 2, an amount of optical loss was about 4.8 dB/cm when no magnetic field was applied to the optical waveguide 10, whereas the amount of optical loss was about 12 dB/cm when a magnetic field of 3500G was applied to the optical waveguide 10. Namely, this showed that an optical loss of about 7.2 dB/cm was controlled by the magnetic field of 3500G.

FIG. 2 shows that at the time when no magnetic field is applied (little optical loss occurs) is made to correspond to an on-state and at the time when the magnetic field is applied (a large optical loss occurs) is made to correspond to an off-state, thereby making it possible to cause the optical waveguide shown in FIG. 1 to function as an optical switch. Moreover, this shows that the intensity of an applied magnetic field is changed with time, thereby making it possible to change a light intensity with time and cause the optical waveguide shown in FIG. 1 to function as an optical modulator.

### First Embodiment

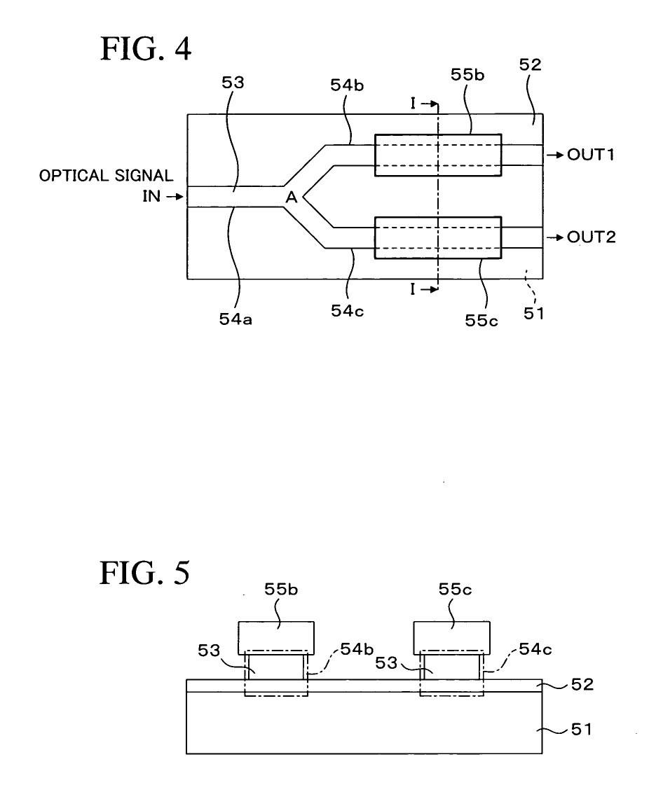

FIG. 4 is a plane view illustrating an optical element according to a first embodiment of the present invention. FIG. 5 is a cross-sectional view taken along a line of I-I of FIG. 4. In addition, the present embodiment shows an example in which the present invention is applied to an optical switch with one input and two outputs (1×2).

As illustrated in FIG. 5, an optical waveguide including a clad 52 made of La_{0.5}Sr_{0.5}CoO₃ and a core 53 made of PLZT, is formed on a SrTiO₃ substrate 51. In the present embodiment, the clad 52 is formed on the entire upper surface of the substrate 51, and the core 53 is branched in a Y shape as illustrated in FIG. 4 and is formed. The optical waveguide, which extends from a signal input terminal IN (left end portion of the core 53 in FIG. 4) to a branch point A, is hereinafter called an input side optical waveguide 54a, and two optical waveguides, which extend from signal output terminals OUT1 and OUT2 (right end portion of the core 53 in FIG. 4) to the branch point A, are hereinafter called output side optical waveguides 54b and 54c, respectively.

A coil (electrical magnet) 55b is placed on the output side optical waveguide 54b and a coil (electrical magnet) 55c is placed on the output side optical waveguide 54c. When current is supplied from a driving circuit (not shown), these coils 55b and 55c generate a magnetic field to change transmittance (optical loss amount) of the optical waveguides 54b and 54c.

The following will explain an operation of the optical switch of the present embodiment. It is assumed that no current is supplied to the coils 55b and 55c in an initial state. In this state, an optical signal input to the input side optical waveguide 54a from the signal input terminal IN is branched at the branch point A, and one optical signal is output from the output terminal OUT1 through the output side optical waveguide 54b and the other optical signal is output from the output terminal OUT2 through the output side optical waveguide 54c. Namely, in the initial state, both the output side optical waveguides 54b and 54c are in an on-state and the optical signals each having a predetermined intensity are output from the output terminal OUT1 and OUT2.

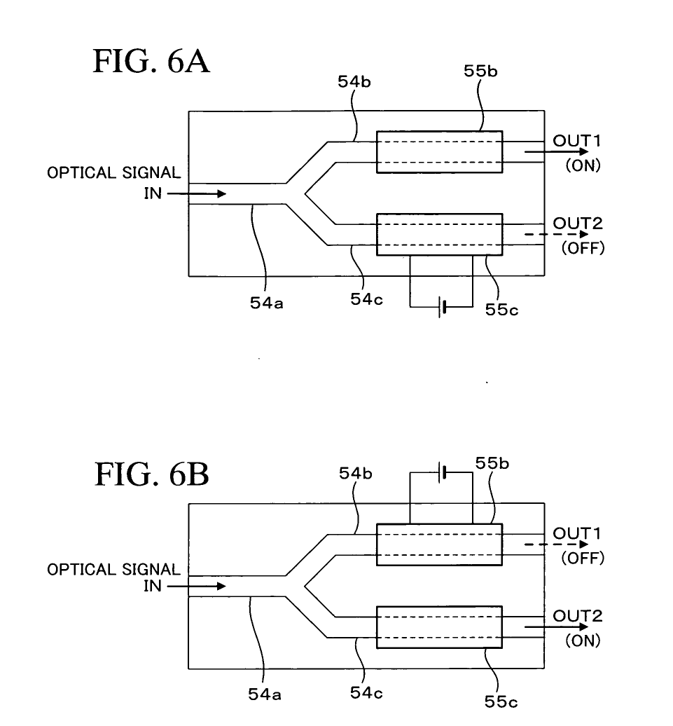

Then, as illustrated in FIG. 6A, when current supply to the coil 55c is started, a magnetic resistance of a lower portion of the coil 55c of the clad 52 is changed by a magnetic field generated by the coil 55c, and a part of the optical signal, which propagates through the output side optical waveguide 54c, is absorbed by the clad 52 to generate loss in the optical signal. Namely, the output side optical waveguide 54c is in an off-state and intensity of the optical signal output from the signal output terminal OUT2 is considerably reduced. On the other hand, since no current is supplied to the coil 55b, the output side optical waveguide 54b remains in an on-state, and an optical signal with a predetermined intensity is output from the signal output terminal OUT1.

Next, as illustrated in FIG. 6B, when a current supply to the coil 55c is stopped and a current supply to the coil 55b is started, the magnetic resistance of the lower portion of the coil 55b of the clad 52 is changed by a magnetic field generated by the coil 55b, and a part of the optical signal, which propagates through the output side optical waveguide 54b, is absorbed by the clad 52 to generate loss in the optical signal. Namely, the output side optical waveguide 53b becomes in an off-state and intensity of the optical signal output from the signal output terminal OUT1 is considerably reduced. On the other hand, since no current is supplied to the coil 55c, the output side optical waveguide 54c becomes in an on-state and an optical signal with a predetermined intensity is output from the signal output terminal OUT2. In this way, switching of the optical signals is performed.

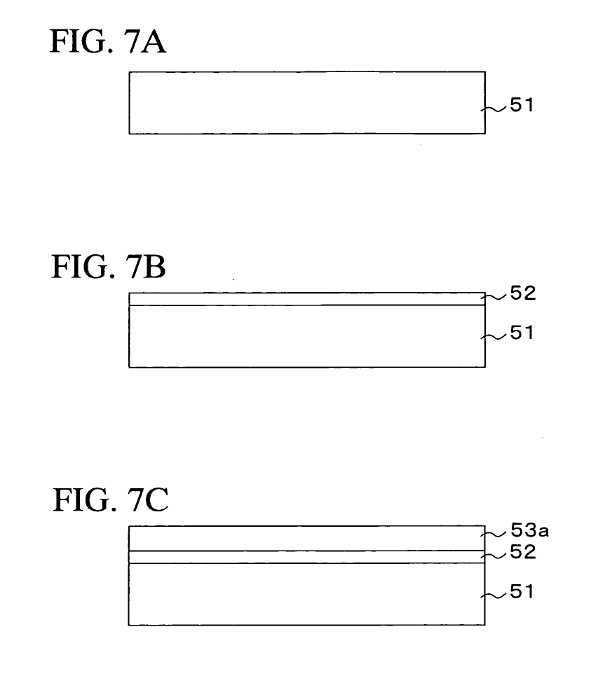

FIGS. 7A to 7C are cross-sectional views illustrating a manufacturing method of the optical switch of the aforementioned embodiment, in the order of processes.

First, as illustrated in FIG. 7A, the substrate 51 is prepared. As the substrate 51, for example, a single crystal substrate, which contains any one of compounds of SrTiO₃, MgO, LaAlO₃, LiNbO₃, and LiTaO₃ as a principal component, is used. In the present embodiment, an Nb-doped SrTiO₃ (111) single crystal conductive substrate is used. The size of the substrate 51 is, for example, 10 mm in width, 50 mm in length, and 0.5 mm in thickness.

Next, as illustrated in FIG. 7B, the clad 52 made of the La_{0.5}Sr_{0.5}CoO₃ is formed to have a thickness about, for example, 100 nm. In the present embodiment, the clad 52 is film-formed in an oxygen atmosphere at substrate temperature of 300° C.˜800° C. and 1 mTorr to 500 mTorr (0.133 Pa to 66.5 Pa) pressure by a laser ablation method using an Nd-YAG laser (this is also called PLD (Pulsed Laser Deposition)). It is noted that the clad 52 may be formed by a method other than the laser ablation method.

The clad 52 must be formed of material having a refractive index lower than that of the core 53 and showing a magnetic resistance effect. Compounds such as perovskite structured (CaₓSr₁₋ₓ)RuO₃ (in this case, 0≦x≦1), (BaₓSr₁₋ₓ)RuO₃ (in this case, 0≦x≦1), (LaₓS₁₋ₓ)CoO₃ (in this case, 0≦x≦1), and (LaₓSr₁₋ₓ)MnO₃ (in this case, 0≦x≦1) can be used as such material.

Next, as shown in FIG. 7C, a core layer 53a made of PLZT is formed on the clad 52 to have a thickness about, for example, 2 μm and a core layer 53a is patterned to form a core 53. The following shows a method of forming the core layer 53a by a sol-gel process. However, the core layer 53a may be formed by a method other than the so-gel process.

First of all, chemicals as raw materials are prepared. In this embodiment, Pd(CH₃COO)₂.3H₂O (lead acetate) is used as an organic compound for Pd, La(i-OC₃H₇)₃ (lanthanum isopropoxide) is used as an organic compound for La, Ti(i-OC₃H₇)₄ (titanium isopropoxide) is used as an organic compound for Ti, and Zr(OC₃H₇)₄ (zirconium propoxide) is used as an organic compound for Zr. Moreover, CH₃COCH₂COCH₃ (2,4-pentanedione) is used as a stabilizer, and CH₃OC₂H₄OH (2-methoxyethanol) is used as a solvent.

Subsequently, a PLZT solution is synthesized by reflux using materials including the aforementioned organic compounds, stabilizer, and the solvent. In order for a composition ratio among La, Zr and Ti of PLZT to be 9:65:35, a mole ratio between Pb(CH₃COO)₂.3H₂O and La(i-OC₃H₇)₃ may be 101:9, and a mole ratio between Zr(OC₃H₇) and Ti(i-OC₃H₇)₄ may be 65:35.

Next, the clad 52 is coated with the PLZT solution, which was synthesized by the aforementioned method, by a spin coat method. Then, temporary burning is performed at temperature of 350° C. and thereafter burning is further performed at temperature of 750° C. in an oxygen atmosphere. This forms a PLZT film with a thickness of about 120 μm. Since only the PLZT film with a thickness of about 120 μm can be formed in one PLZT film forming process by the sol-gel process, the respective step processes of coating, temporary burning, and burning are repeated a plurality of times, thereby layering the PLZT films to form the core layer 53a with a desired thickness (for example, 2 μm).

After forming the core layer 53a on the clad 52 as mentioned above, an etching mask (not shown) is formed on the core layer 53a by a photolithography method. Then, a wet etching or dry etching is carried out to pattern the core layer 53a to a desired shape. Since the optical switch with one input and two outputs is formed in the present embodiment, the core layer 53a is patterned in a Y shape to form the core 53 as illustrated in FIG. 4. When the core layer 53a is patterned by the wet etching, a mixed solution of, for example, HCl and HF is used as an etchant. When the core layer 53a is patterned by the dry etching, a mixed gas of, for example, Ar (argon) and Cl (chlorine) is used as an etching gas. Then, the core layer 53a is patterned to form the core 53, thereafter the etching mask is removed therefrom. In this manner, a Y-shape optical waveguide including the clad 52 and the core 53, namely, the input side optical waveguide 54a and the output side optical waveguides 54b and 54c are formed.

Subsequently, as illustrated in FIGS. 4 and 5, the coils 55b and 55c are bonded onto the output side optical waveguides 54b and 54c, thereby completing the optical switch of the present embodiment. In the present embodiment, a surface-mount type stacked coil or winding coil, which is marketed for use in a surface-mount onto a print board, is used as coils 55b and 55c.

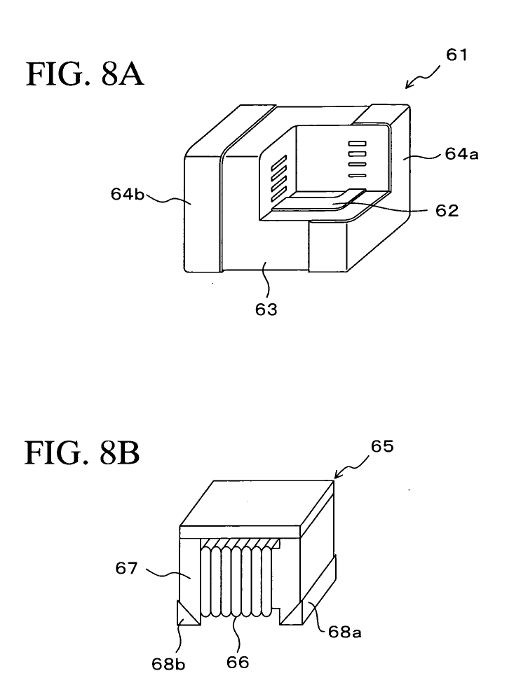

FIG. 8A illustrates an example (perspective view showing a partially notched state) of a commercial surface-mount type stacked coil, and FIG. 8B illustrates an example (perspective view) of a commercial surface-mount type winding coil. A surface-mount type stacked coil 61 shown in FIG. 8A has a structure, in which a coil 62 made of a thin film conductive material, is buried in a ferrite 63. Both ends of the coil 62 are connected to electrodes 64a and 64b, respectively, and power is supplied from a driving circuit (not shown) through these electrodes 64a and 64b.

A surface-mount type winding coil 65 shown in FIG. 8B has a structure in which an electric wire 66 is wound around a center of a core 67 having an H-shape cross-section. Both ends of the electric coil 66 are connected to electrodes 68a and 68b, respectively, and power is supplied from a driving circuit (not shown) through these electrodes 68a and 68b.

The optical switch of the present embodiment is structured to have the coils 55b and 55c on the Y-shape optical waveguide, so that the manufacture is easily carried out. Furthermore, since the optical switch of the present embodiment does not have to form thin film electrodes on the optical waveguide unlike an optical element which changes a refractive index of the optical waveguide by an electric field (optical element as described in the aforementioned patent document 1), the optical loss due to electrodes does not occur. Moreover, since the optical switch of the present embodiment switches the optical signals, which propagate through the optical waveguide, by the magnetism, the operation speed is higher than that of a mechanically-driven optical switch. Still moreover, since the optical switch of the present embodiment is manufactured by film-forming the clad 52 and the core 53 on the substrate 51, integration is easily carried out.

In addition, although the present embodiment uses the commercial core coils shown in FIGS. 8A and 8B as magnetic field applying means, it is possible to use various kinds of coils such as an air-core coil, an iron-core coil or a thin film coil formed by a thin film technique as the magnetic field applying means. When a magnetic material is used as the core material of a core coil, there is a case where the magnetic field is always applied to the optical waveguide, so that the coil must be designed taking this point into consideration.

### Second Embodiment

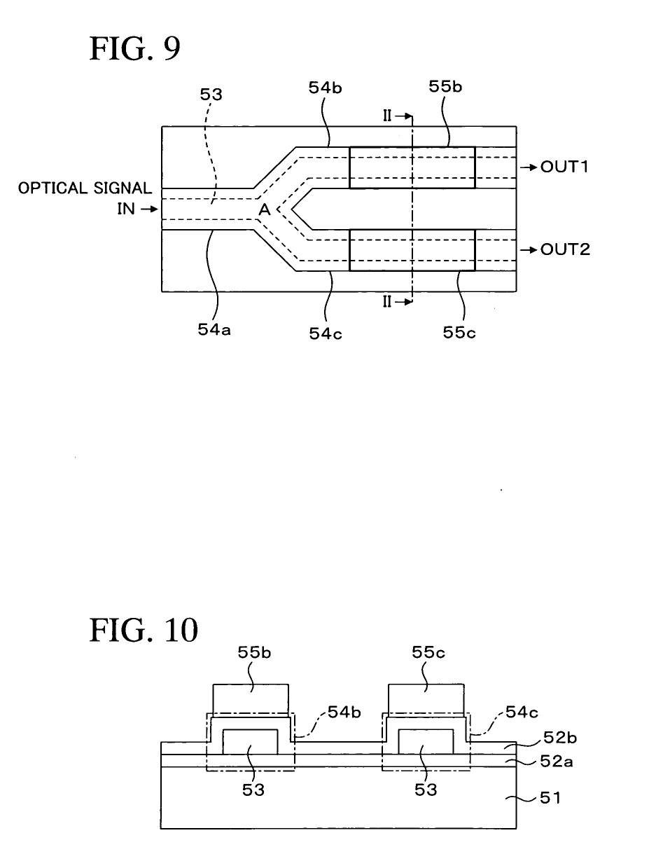

FIG. 9 is a plane view illustrating an optical element (optical switch) according to a second embodiment of the present invention, and FIG. 10 is a cross-sectional view taken along the line of II-II of FIG. 9. In addition, this embodiment is different from the first embodiment in the point that the core 53 is surrounded by the clad while the other components are basically the same as those of the first embodiment. Accordingly, the components of FIGS. 9 and 10 identical to those of FIGS. 4 and 5 are assigned the same reference numerals and their detailed explanation is omitted.

As illustrated in FIG. 10, the lower clad (first clad layer) 52a made of La_{0.5}Sr_{0.5}CoO₃ is formed on the SrTiO₃ substrate 51 and the core 53 made of PLZT is formed on the lower clad 52a. The optical switch of this embodiment is also an optical switch with one input and two outputs and the core 53 is patterned in a Y-shape, similar to the first embodiment (see FIG. 9).

An upper clad (second clad layer) 52b made of La_{0.5}Sr_{0.5}CoO₃ is formed on the lower clad 52a and the core 53 and the upper surface and side surface of the core 53 are covered with the upper clad 52b. The optical waveguide includes the lower clad 52a, the core 53 and the upper clad 52b. Likewise, in this embodiment, the optical waveguide, which extends from the signal input terminal IN (left end portion of the core 53 in FIG. 9) to the branch point A, is hereinafter called the input side optical waveguide 54a, and two optical waveguides, which extend from the branch point A to the signal output terminals OUT1 and OUT2 (right end portion of the core 53 in FIG. 9), are hereinafter called output side optical waveguides 54b and 54c, respectively. The coil 55b is placed on the output side optical waveguide 54b and the coil 55c is placed on the output side optical waveguide 54c.

The optical switch of this embodiment can also obtain the same effect as that of the first embodiment since the lower clad 52a and the upper clad 52b are formed of the materials showing the magnetic resistance effect. Moreover, since the core 53 is surrounded by the lower clad 52a and the upper clad 52b, the present embodiment has an advantage in which the amount of optical loss of the optical waveguide due to the magnetic field is large as compared with the first embodiment, thereby making it possible to reduce the lengths of the output side optical waveguides 54b and 54c.

Additionally, in this embodiment, both the lower clad 52a and the upper clad 52b are formed of the materials showing the magnetic resistance effect. However, if there is no need to reduce the lengths of the output side optical waveguides 54b and 54c, only one of the lower clad 52a and the upper clad 52b may be formed of the material showing the magnetic resistance effect and the other may be formed of material showing no magnetic resistance effect.

### Third Embodiment

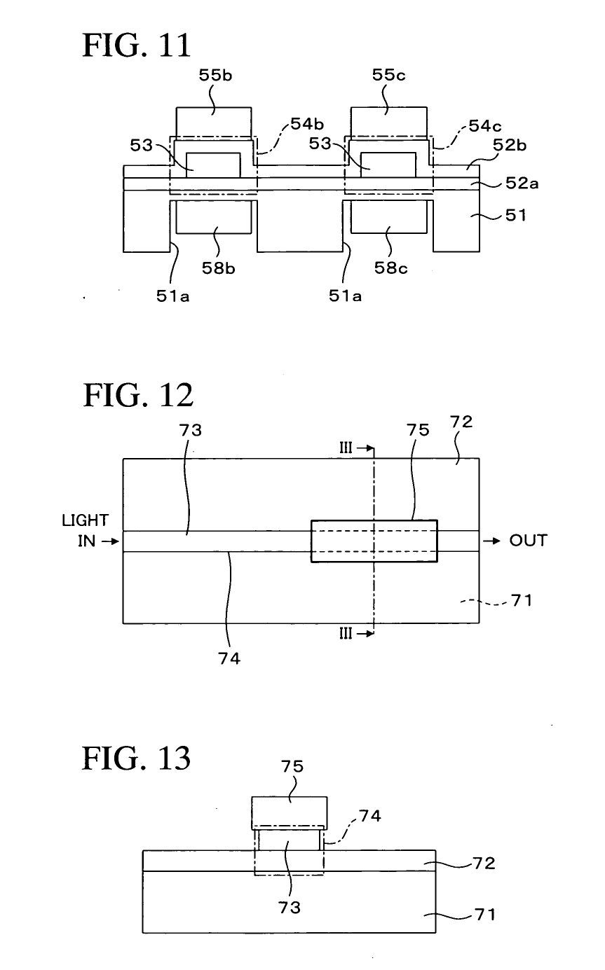

FIG. 11 is a cross-sectional view illustrating an optical element (optical switch) according to a third embodiment of the present invention. In addition, this embodiment is different from the second embodiment in the point that coils are placed on not only the upper sides of the output side optical waveguides 54b and 54c but also the lower portions thereof. Since the other components are basically the same as those of the second embodiment, the components of FIG. 11 identical to those of FIG. 10 are assigned the same reference numerals and their detailed explanation is omitted.

In the present embodiment, concave portions 51a are formed at positions conforming to the output side optical waveguides 54b and 54c of the back surface of the substrate 51, respectively. Then, coils 58b and 58c are placed in these concave portions 51a. Namely, in this embodiment, the optical loss of the output side optical waveguide 54b is controlled by the coils 55b and 58b placed on the upper and lower sides of the output side optical waveguide 54b, and the optical loss of the output side optical waveguide 54c is controlled by the coils 55c and 58c placed on the upper and lower sides of the output side optical waveguide 54c.

In this embodiment, since the core 53 is surrounded by the lower clad 52a and the upper clad 52b formed of the materials showing the magnetic resistance effect similar to the optical switch of the second embodiment, the same effect as that of the second embodiment can be obtained. Moreover, the optical switch of this embodiment controls the optical loss of the output side optical waveguides 54b and 54c by each two coils (coils 54b and 58b or coils 54c and 58c), so that the amount of optical loss of the optical waveguide due to the magnetic field is further increased as compared with the optical switch of the second embodiment. Accordingly, the optical switch of this embodiment has an advantage in which the lengths of the output side optical waveguides 54b and 54c can be further reduced as compared with the optical switch of the second embodiment.

### Fourth Embodiment

FIG. 12 is a plane view illustrating an optical element according to a fourth embodiment of the present invention. FIG. 13 is a cross-sectional view taken along the line of III-III of FIG. 12. This embodiment shows an example in which the present invention is applied to an optical modulator.

A clad 72 made of La_{0.5}Sr_{0.5}CoO₃ is formed on a single crystal substrate 71 made of Nb-doped SrTiO₃. Moreover, a core 73 made of PLZT is formed on the clad 72 to construct an optical waveguide 74. Furthermore, a surface-mount type stacked coil 75 is placed on the core 73.

In the above-structured optical modulator of this embodiment, when light with a predetermined intensity is input from the input terminal IN and current, which is supplied to the coil 75 from a driving circuit (not shown) according to a modulation signal, is on/off controlled, transmittance (optical loss) of the optical waveguide 74 is changed according to the modulation signal and a modulation light is output from the output terminal OUT.

Similar to the first embodiment, the clad 72 made of La_{0.5}Sr_{0.5}CoO₃ is formed on the substrate 71 by the laser ablation method and the core 73 made of PLZT is formed thereon by the sol-gel process, and thereafter the commercial surface-mount type stacked coil 75 is placed on the core 73, thereby manufacturing the optical modulator of this embodiment.

The optical modulator of this embodiment on/off-controls the magnetic field to be applied to the optical waveguide 74 to change an intensity of light, which propagates through the optical waveguide 74, and to generate the modulation light. In this embodiment, since the loss of light, which propagates through the optical waveguide 74, is also controlled by the magnetism, the high speed operation is possible and the manufacture is easily carried out. Moreover, since the optical modulator of the present embodiment is manufactured by film-forming the clad 72 and the core 73 on the substrate 71, integration is easily carried out.

What is claimed is:

1. An optical element comprising:
a substrate;
an optical waveguide including a clad made of material showing a magnetic resistance effect and a core made of material having a higher refractive index than that of the clad, the optical waveguide being placed on the substrate; and
magnetic field applying means which applies a magnetic field to the optical waveguide to control an intensity of light propagating through the optical waveguide.

2. The optical element according to claim 1, wherein the clad is formed on only one of upper and lower sides of the core.

3. The optical element according to claim 1, wherein the clad includes a first clad layer formed between the substrate and the core, and a second clad layer which covers side and upper surfaces of the core.

4. The optical element according to claim 1, wherein the clad contains at least one of compounds of (CaₓSr₁₋ₓ)RuO₃ (in this case, 0≦x≦1), (BaₓSr₁₋ₓ)RuO₃ (in this case, 0≦x≦1), (LaₓSr₁₋ₓ)CoO₃ (in this case, 0≦x≦1), and (LaₓSr₁₋ₓ)MnO₃ (in this case, 0≦x≦1) as a principal component.

5. The optical element according to claim 1, wherein the core contains at least one of compounds of PLZT, SrTiO₃, MgO, LaAlO₃, LiNbO₃, and LiTaO₃ as a principal component.

6. The optical element according to claim 1, wherein the substrate contains at least one of compounds of SrTiO₃, MgO, LaAlO₃, LiNbO₃ and LiTaO₃ as a principal component.

7. The optical element according to claim 1, wherein a compound which forms the clad has a perovskite structure.

8. The optical element according to claim 1, wherein the optical waveguide includes one input side optical waveguide and two output side optical waveguides connected to the input side optical waveguide, and the magnetic field applying means is provided for each output side optical waveguide.

9. The optical element according to claim 1, wherein the magnetic field applying means is a surface-mount type coil.

10. The optical element according to claim 1, wherein the magnetic field applying means is placed on both upper and lower sides of the optical waveguide.

11. A manufacturing method of an optical element, comprising the steps of:
forming an optical waveguide including a clad made of material showing a magnetic resistance effect and a core made of material having a higher refractive index than that of the clad, on a substrate; and
placing magnetic field applying means which applies a magnetic field to the optical waveguide, on at least one of upper and lower sides of the substrate.

12. The manufacturing method of the optical element according to claim 11, wherein the clad is formed of at least one of compounds of (CaₓSr₁₋ₓ)RuO₃ (in this case, 0≦x≦1), (BaₓSr₁₋ₓ)RuO₃ (in this case, 0≦x≦1), (LaₓS₁₋ₓ)CoO₃ (in this case, 0≦x≦1), and (LaₓSr₁₋ₓ)MnO₃ (in this case, 0≦x≦1).

13. The manufacturing method of the optical element according to claim 12, wherein the clad is formed by a laser ablation method.

14. The manufacturing method of the optical element according to claim 11, wherein the core is formed of at least one of compounds of PLZT, SrTiO₃, MgO, LaAlO₃, LiNbO₃, and LiTaO₃.

15. The manufacturing method of the optical element according to claim 11, wherein a surface-mount type coil is used as the magnetic field applying means.

16. A driving method of an optical element, wherein a magnetic field is applied to an optical waveguide including a clad made of material showing a magnetic resistance effect and a core made of material having a higher refractive index than that of the clad, the optical waveguide being placed on a substrate to control an intensity of light propagating through the optical waveguide.
